(19) United States
(12) Patent Application Publication
(10) Pub. No.: US 2017/0263037 A1
(43) Pub. Date: Sep. 14, 2017

(54) IMAGE PROCESSING DEVICE, IMAGE PROCESSING SYSTEM, IMAGE PROCESSING METHOD, AND NON-TRANSITORY COMPUTER READABLE MEDIUM

(71) Applicant: FUJI XEROX CO., LTD., Tokyo (JP)

(72) Inventors: Kosuke MARUYAMA, Kanagawa (JP); Keiko MATSUBAYASHI, Kanagawa (JP)

(73) Assignee: FUJI XEROX CO., LTD., Tokyo (JP)

(21) Appl. No.: 15/255,937

(22) Filed: Sep. 2, 2016

(30) Foreign Application Priority Data
Mar. 9, 2016 (JP) 2016-045529

(51) Int. Cl. G06T 13/80; G06T 1/00

(52) U.S. Cl. CPC G06T 13/80; G06T 1/0007

(57) ABSTRACT

An image processing device includes an acquisition unit and an output unit. The acquisition unit acquires a still image. The output unit outputs a continuous image constituted by temporally arranging plural composite images each prepared by combining each of plural non-continuous random images with the still image.

### CROSS-REFERENCE TO RELATED APPLICATIONS

This application is based on and claims priority under 35 USC 119 from Japanese Patent Application No. 2016-045529 filed Mar. 9, 2016.

### BACKGROUND

(i) Technical Field

The present invention relates to an image processing device, an image processing system, an image processing method, and a non-transitory computer readable medium.

(ii) Related Art

There exists a technique generally called “Graphics Interchange Format (GIF) animation” in which plural GIF images are connected to express motion. There is also known a technique called “cinemagraph” which is a type of the GIF animation that contains motion in only a part of an image using movie data. In recent years, further, there has been proposed a technique called “deformation lamp” which gives an impression that an image contains motion.

### SUMMARY

According to an aspect of the present invention, there is provided an image processing device including: an acquisition unit that acquires a still image; and an output unit that outputs a continuous image constituted by temporally arranging plural composite images each prepared by combining each of plural non-continuous random images with the still image.

### BRIEF DESCRIPTION OF THE DRAWINGS

Exemplary embodiments of the present invention will be described in detail based on the following figures, wherein:

FIG. 1 illustrates an example of the configuration of an image processing system according to exemplary embodiments;

FIG. 2 is a block diagram illustrating an example of the functional configuration of an image processing device according to a first exemplary embodiment;

FIG. 3 is a flowchart illustrating an example of the procedure of a process performed by the image processing device;

FIGS. 4A to 4C illustrate a specific example of the process performed by the image processing device;

FIG. 5 illustrates an example of a process in which a user specifies a region in a background image to be combined with a mask image;

FIG. 6 illustrates an example of Perlin noise at varied frequencies;

FIG. 7 illustrates an example of a process for combining mask images generated using different noise variables with plural regions;

FIGS. 8A to 8D illustrate examples of a mask image that has directivity;

FIGS. 9A to 9C illustrate other examples of the mask image that has directivity; and

FIG. 10 illustrates an example of the hardware configuration of the image processing device.

### DETAILED DESCRIPTION

<Description of Entire Image Processing System>

An exemplary embodiment of the present invention will be described in detail below with reference to the accompanying drawings.

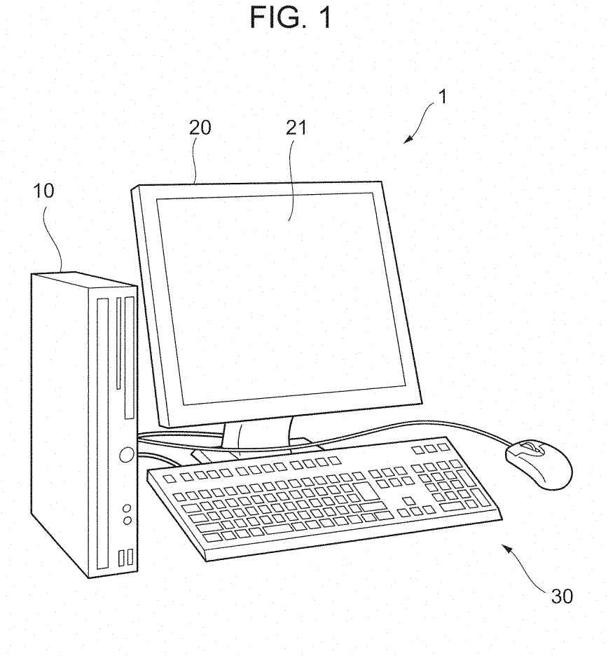

FIG. 1 illustrates an example of the configuration of an image processing system 1 according to exemplary embodiments.

As illustrated in the drawing, the image processing system 1 according to the exemplary embodiments includes an image processing device 10 that performs image processing on image information on an image to be displayed on a display device 20, the display device 20 which receives the image information prepared by the image processing device 10 to display an image on the basis of the image information, and an input device 30 for a user to input a variety of information to the image processing device 10.

The image processing device 10 is a so-called general-purpose personal computer (PC), for example. The image processing device 10 is adapted to cause various types of application software to operate under the management by an operating system (OS) to prepare the image information, for example.

The display device 20 displays an image on a display screen 21. The display device 20 may be a liquid crystal display for a PC, a liquid crystal television set, or a projector, for example, which is configured to provide a function of displaying an image through additive color mixing. Thus, the display device 20 may adopt a display method other than the liquid crystal method. In the example illustrated in FIG. 1, the display screen 21 is provided in the display device 20. However, in the case where the display device 20 is a projector, for example, the display screen 21 may be a screen or the like provided external to the display device 20.

The input device 30 may be a keyboard and a mouse. The input device 30 is used to start and end application software for image processing, and used by the user to input an instruction for the image processing to the image processing device 10 when the image processing is performed, as discussed in detail later.

The image processing device 10 and the display device 20 are connected to each other via a Digital Visual Interface (DVI). The components may be connected via a High-Definition Multimedia Interface (HDMI) (registered trademark), a DisplayPort, or the like in place of the DVI.

The image processing device 10 and the input device 30 are connected to each other via a Universal Serial Bus (USB), for example. The components may be connected via an IEEE 1394 port, an RS-232C port, or the like in place of the USB.

In such an image processing system 1, the display device 20 first displays an image to be subjected to the image processing (hereinafter referred to as a “background image”) as the original image before the image processing. The background image is a still image. When the user uses the input device 30 to input an instruction for the image processing to the image processing device 10, the image processing device 10 performs the image processing on the image information on the background image. As discussed later, the image processing is a process for applying a mask image to the background image, in other words a process for combining the background image and the mask image. The result of the image processing is reflected in the image to be displayed on the display device 20, and an image after the image processing is redrawn to be displayed on the display device 20. In this case, the user may interactively perform the image processing while seeing the display device 20, and perform the work of the image processing more intuitively and more easily.

The image processing system 1 according to the exemplary embodiments is not limited to the form of FIG. 1. For example, the image processing system 1 may be implemented as a tablet terminal. In this case, the tablet terminal includes a touch screen, and an image is displayed and an instruction from the user is input through the touch screen. That is, the touch screen functions as the display device 20 and the input device 30. Likewise, a touch monitor may also be used as a device that integrates the display device 20 and the input device 30. In the touch monitor, a touch screen is used as the display screen 21 of the display device 20. In this case, image information is prepared by the image processing device 10, and an image is displayed on the touch monitor on the basis of the image information. The user touches the touch monitor, for example, to input an instruction for the image processing.

### First Exemplary Embodiment

### <Image Processing Device>

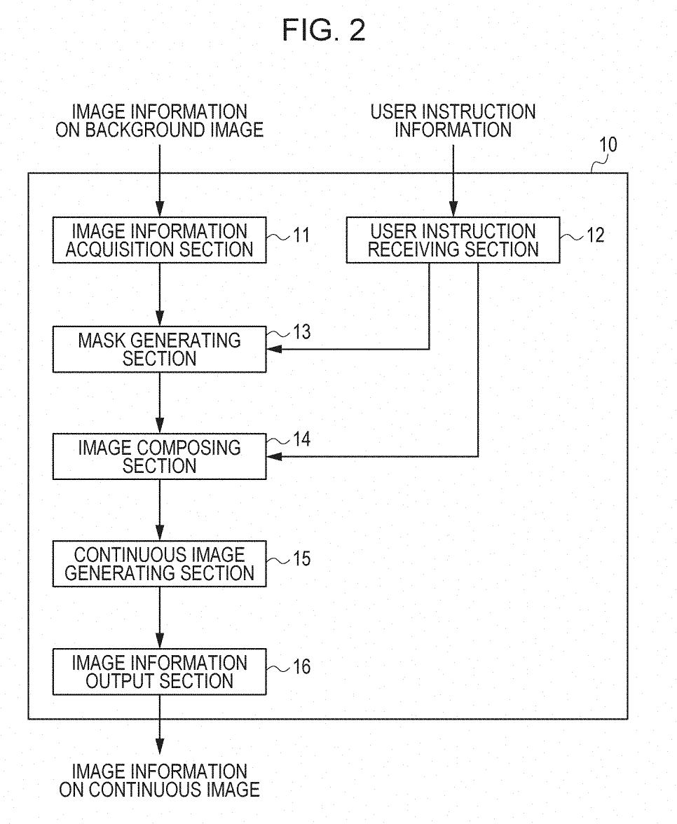

Next, the image processing device 10 according to a first exemplary embodiment will be described. FIG. 2 is a block diagram illustrating an example of the functional configuration of the image processing device 10 according to the first exemplary embodiment; As illustrated in the drawing, the image processing device 10 according to the first exemplary embodiment includes an image information acquisition section 11, a user instruction receiving section 12, a mask generating section 13, an image combining section 14, a continuous image generating section 15, and an image information output section 16.

The image information acquisition section 11, which is an example of the acquisition unit, acquires image information on a background image to be subjected to the image processing. That is, the image information acquisition section 11 acquires a background image which is the original image before the image processing. The image information is video data (RGB data) for red, green, and blue (RGB), for example, to be displayed on the display device 20.

The user instruction receiving section 12 receives an instruction for the image processing input by the user using the input device 30.

Specifically, the user instruction receiving section 12 receives, as user instruction information, an instruction given by the user for the image processing to be performed on the background image displayed on the display device 20, for example.

The mask generating section 13 generates plural different non-continuous mask images to be combined with the background image. The mask images are images generated on the basis of random noise. Examples of the random noise include Perlin noise which is commonly used. In the case where the mask images are generated on the basis of random noise (Perlin noise) which represents the brightness/darkness (or thickness/paleness) of color, for example, the pixels of the mask images are randomly given any of 256 levels of achromatic color, for example. More specifically, if the image information on a mask image is RGB data, for example, the pixel values of pixels of the mask image are determined such that the three RGB values, namely the R value, the G value, and the B value, are equal and have any value from 0 to 255. In the first exemplary embodiment, the mask images are used as an example of the non-continuous random images. In other words, in the case where the mask images (random images) are seen as a collection of such images, the images are commonly characterized in being generated on the basis of random noise, and are non-continuous with each other.

The image combining section 14 combines the mask images generated by the mask generating section 13 with the background image. The plural mask images have been generated by the mask generating section 13. The image combining section 14 generates, for each of the mask images, a composite image obtained by combining the background image and the mask image.

A variety of methods may be used as a combining process for combining the background image and the mask image. Examples of the combining process include a process performed using [Expression 1] below.

In [Expression 1], Eᵢⱼ is a color value at the position (i, j) of each pixel that constitutes the composite image generated by combining the background image and the mask image. Mᵢⱼ is a color value at the position (i, j) of each pixel that constitutes the mask image. Iᵢⱼ is a color value at the position (i, j) of each pixel that constitutes the background image. In the case where the background image and the mask image are RGB data, for example, three values, namely the R value, the G value, and the B value, are provided as Iᵢⱼ, and three values, namely the R value, the G value, and the B value, are provided as Mᵢⱼ. Then, three values, namely the R value, the G value, and the B value, are calculated as Eᵢⱼ using [Expression 1].

E_{i,j}=M_{i,j}+I_{i,j} [Expression 1]

Incidentally, the color value of a certain pixel of the composite image calculated using [Expression 1] is considered as the sum of the color value of a pixel at the position of the mask image superposed on the upper side and the color value of a pixel at the same position of the background image on the lower side. The color value of a pixel should fall within the range of 0 to 255. Therefore, the color value is determined as 0 if the color value is a negative value as a result of calculation, and determined as 255 if f the color value is equal to or more than 255.

The combining process is not limited to the method of [Expression 1], and may be a method called “overlay” or a method called “screen”, for example.

The overlay combining process is performed using [Expression 2] below, for example. The screen combining process is performed using [Expression 3] below, for example.

$$\begin{matrix}{E}_{i , j} = \frac{{I}_{i , j}}{255} ( {I}_{i , j} + \frac{2 {M}_{i , j}}{255} ( 255 - {I}_{i , j} ) ) & [ Expression 2 ] \\ {E}_{i , j} = 255 - \frac{( 255 - {M}_{i , j} ) ( 255 - {I}_{i , j} )}{255} & [ Expression 3 ]\end{matrix}$$

The user may designate, as a region to be combined with the mask image, a part (or all) of the region in the background image. In this case, the image combining section 14 combines the mask image with the region in the background image designated by the user on the basis of the instruction received by the user instruction receiving section 12.

The continuous image generating section 15 generates a continuous image constituted by temporally arranging plural composite images obtained after the image combining section 14 has performed the combining process for each of the mask images. Incidentally, the continuous image includes the plural composite images sequentially changed over at predetermined intervals (of e.g. 100 milliseconds).

The image information output section 16, which is an example of the output unit, outputs image information on the continuous image generated by the continuous image generating section 15. The image information on the continuous image is sent to the display device 20. The display device 20 displays the continuous image on the basis of the image information. That is, the display device 20 displays the plural composite images sequentially changed over at the predetermined intervals (of e.g. 100 milliseconds).

In general, human vision has a nature that it tries to find regularity (continuity) in something random or irregular (non-continuous). The first exemplary embodiment utilizes such a nature of the human vision. More specifically, an impression that a still image (background image) is continuously moving is invoked by combining the still image and each of plural mask images, in other words by applying random noise varied over time (as the time passes) to the still image.

<Procedure of Process by Image Processing Device>

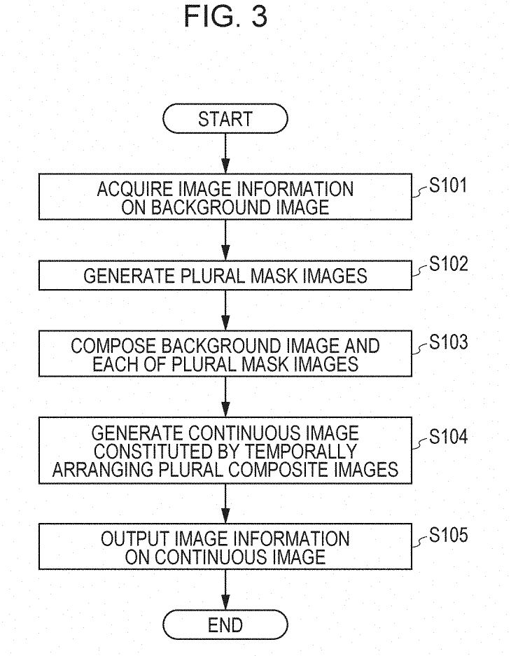

Next, the procedure of the process performed by the image processing device 10 will be described. FIG. 3 is a flowchart illustrating an example of the procedure of the process performed by the image processing device 10.

First, the image information acquisition section 11 acquires image information on a background image to be subjected to the image processing (S101). For example, the image information acquisition section 11 acquires image information on a background image by the user selecting a background image to be subjected to the image processing from images displayed on the display device 20. Next, the mask generating section 13 generates plural mask images to be applied to the background image (S102). The mask generating section 13 generates plural mask images on the basis of Perlin noise, for example.

Next, the image combining section 14 combines the background image and each of the plural mask images (S103). The image combining section 14 executes, for each of the mask images, a process for combining the mask image with a designated region in the background image on the basis of an instruction received by the user instruction receiving section 12. The image combining section 14 generates plural composite images.

Next, the continuous image generating section 15 generates a continuous image constituted by temporally arranging the plural composite images (S104). The image information output section 16 outputs image information on the generated continuous image (S105). The output image information is sent to the display device 20 so that the continuous image is displayed on the display device 20. The process flow is ended.

<Specific Example of Process by Image Processing Device>

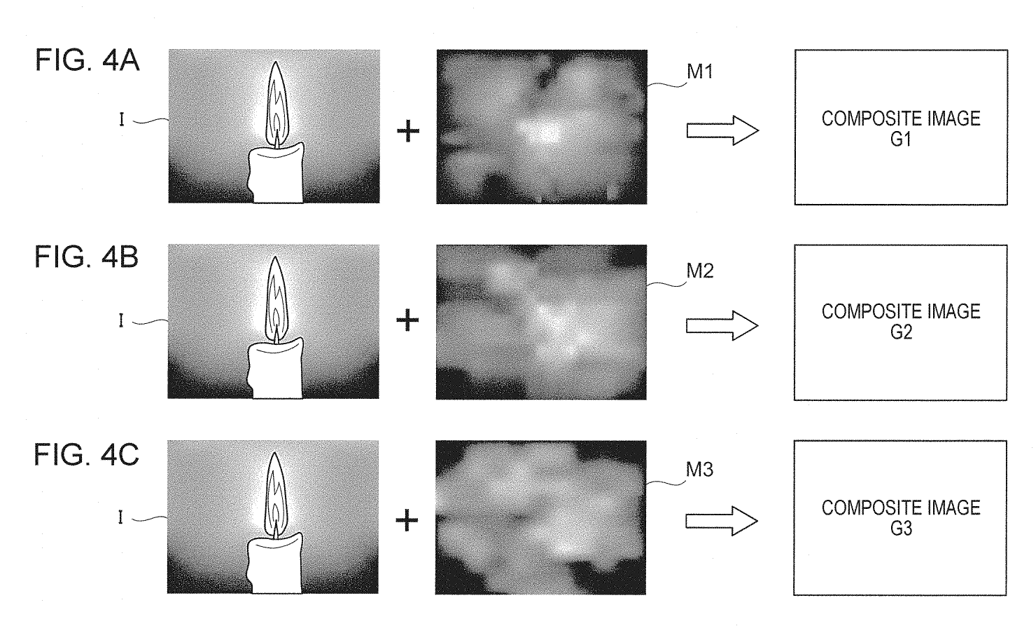

Next, the process performed by the image processing device 10 will be described with reference to a specific example. FIGS. 4A to 4C illustrate a specific example of the process performed by the image processing device 10. In the examples illustrated in FIGS. 4A to 4C, the mask images are combined with the entire background image.

In the examples illustrated in FIGS. 4A to 4C, background images I and mask images M (a mask image M1 in FIG. 4A, a mask image M2 in FIG. 4B, and a mask image M3 in FIG. 4C) are indicated. The background images I are still images that illustrate a flame burning at the end of the wick of a candle. The three background images I are identical images. The mask images M are images generated on the basis of Perlin noise, and the mask images M1 to M3 indicate different noise. In the examples illustrated in FIGS. 4A to 4C, only three mask images M are indicated. However, four or more mask images M may be provided.

The image combining section 14 generates composite images by combining the background image I and each of the mask images M1 to M3. That is, the image combining section 14 generates a total of three composite images, namely a composite image G1 obtained by combining the background image I and the mask image M1, a composite image G2 obtained by combining the background image I and the mask image M2, and a composite image G3 obtained by combining the background image I and the mask image M3.

Next, the continuous image generating section 15 generates a continuous image constituted by temporally arranging the composite images G1 to G3. More specifically, the continuous image generating section 15 generates a continuous image such that the composite images G1, G2, and G3 are sequentially changed over at predetermined intervals (of e.g. 100 milliseconds). The continuous image generating section 15 generates a continuous image by arranging the three composite images in the order of the composite images G1 to G3, for example. Alternatively, the continuous image generating section 15 may generate a continuous image by randomly selecting four or more composite images from the composite images G1 to G3 and temporally arranging the selected composite images such that the same image does not appear consecutively.

When the continuous image generating section 15 generates a continuous image, the image information output section 16 outputs image information on the continuous image. The continuous image is displayed on the display device 20. The display device 20 displays the composite images G1 to G3 sequentially changed over at intervals of 100 milliseconds, for example. The generated continuous image may be displayed repeatedly.

In this way, in the examples illustrated in FIGS. 4A to 4C, the mask images M1 to M3 are combined with the background image I to apply random noise varied over time to an image that illustrates a flame burning at the end of the wick of a candle. Displaying the plural composite images G1 to G3 as sequentially changed over invokes an impression that the flame illustrated in the background image is moving continuously to express a burning flame.

<Example of Instruction for Image Processing Provided by User>

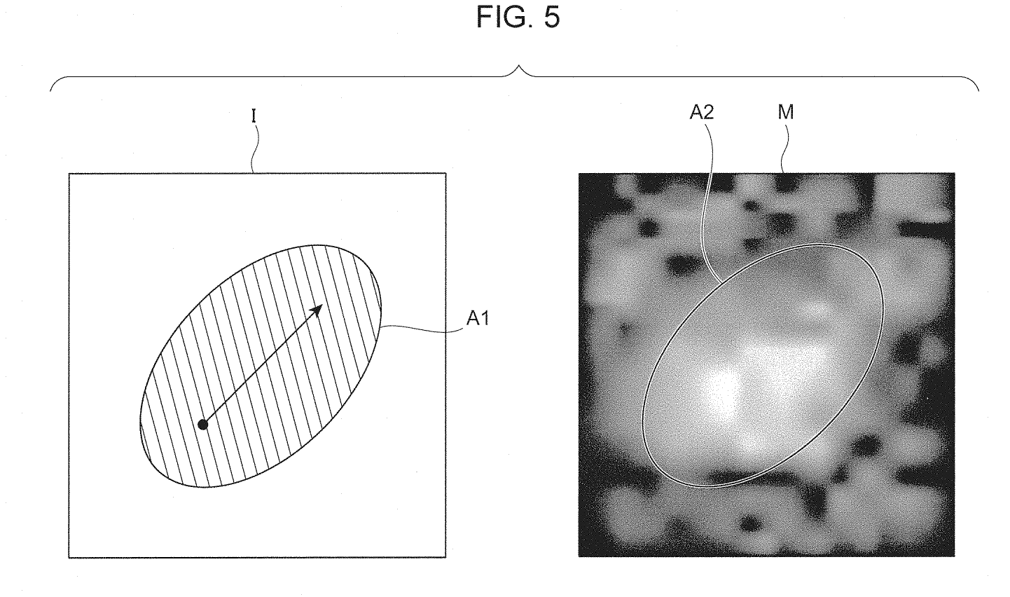

Next, an instruction for the image processing provided by the user will be described. As discussed above, the user may designate a region in a background image to be combined with a mask image. FIG. 5 illustrates an example of a process in which the user specifies a region in a background image to be combined with a mask image. In FIG. 5, the background image I is illustrated on the left side of the drawing, and the mask image M is illustrated on the right side of the drawing. The user designates a location in the background image I using the mouse or the like of the input device 30, and performs a drag operation in the direction indicated by the arrow. As a result of the operation, a region A1 with a predetermined range is designated from the arrow portion directly indicated by the user using the mouse or the like. Incidentally, such an operation performed by the user is an operation for designating a region in the background image I to be combined with the mask image M, and is received by the user instruction receiving section 12.

The image combining section 14 uses an image in a region A2 in the mask image M that is identical to the region A1 (that is, a region that is identical in shape and size to the region A1). In other words, the image combining section 14 performs a process for applying random noise in the region A2 in the mask image to the region A1 in the background image I. The process for applying random noise is executed for each of the mask images M generated by the mask generating section 13. In this way, the image combining section 14 generates plural composite images.

The degree (proportion) of composition of the mask image M (hereinafter referred to as a “composition rate”) may be varied. For example, the image combining section 14 determines that the composition rate is 100% at the arrow portion in the region A1 directly indicated by the user, and varies the composition rate at other locations in the region A1 in accordance with the distance from the arrow portion. When the composition rate is defined as a, the color values of the pixels of the composite image are calculated using [Expression 4] below, for example. [Expression 4] is used in the case where the combining process of [Expression 1] discussed above is performed.

In [Expression 4], Eᵢⱼ is a color value at the position (i, j) of each pixel that constitutes the composite image. Mᵢⱼ is a color value at the position (i, j) of each pixel that constitutes the mask image M. Iᵢⱼ is a color value at the position (i, j) of each pixel that constitutes the background image I. α is the composition rate, and has a value in the range of 0 to 1. For pixels with a composition rate of 100%, for example, α has a value of 1. For pixels with a composition rate of 50%, for example, α has a value of 0.5.

E_{i,j}=α(M_{i,j}+I_{i,j}) [Expression 4]

In the first exemplary embodiment, as described above, the image processing device 10 combines plural mask images that represent random noise varied over time with a background image, and generates a continuous image such that plural composite images are sequentially changed over. Displaying the continuous image invokes an impression that the background image, which is a still image, is moving continuously. Viewers of the continuous image try to find regularity in random noise varied over time when they see the composite images sequentially changed over. Therefore, the viewers are given an impression that the still image is moving continuously. In the first exemplary embodiment, the user may not necessarily perform the work of taking a movie, editing a movie in an advanced manner, and so forth. An impression that the background image contains motion may be given even in the case where the background image contains few high-frequency components.

In the example illustrated in FIG. 4, continuous motion of a flame is expressed. In the first exemplary embodiment, however, random noise may be applied to any object to provide motion. For example, motion of steam, motion of waves, swaying motion of tree leaves, and so forth may be expressed. Incidentally, the first exemplary embodiment is suitable to express motion of an object that does not have contours such as a fluid, rather than moving motion of an object that has contours itself. In the case where random noise varied over time is combined with an image of an object that has contours, continuous variation in state (such as texture or a pattern) of the surface of the object is expressed, for example.

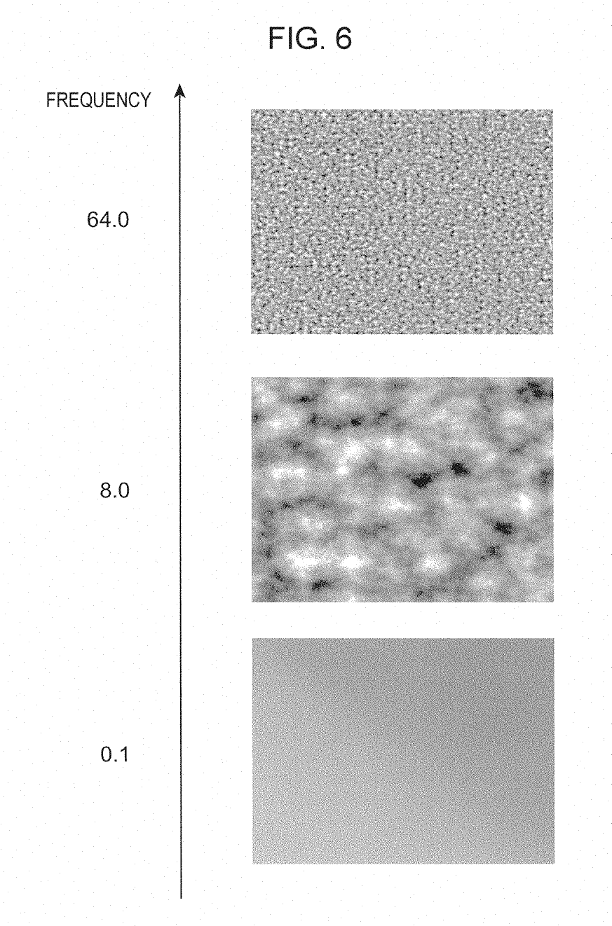

In the first exemplary embodiment, a variable (hereinafter referred to as a “noise variable”) used to generate noise may be designated by the user. For Perlin noise, for example, examples of the noise variable include the frequency, the number of octaves, and the seed value. FIG. 6 illustrates an example of Perlin noise at varied frequencies. As illustrated in FIG. 6, the thickness/paleness of the noise is varied more abruptly as the frequency is higher, and the thickness/paleness of the noise is varied more gently as the frequency is lower. The number of octaves is a value that indicates the number of layers of noise to be combined. Finer noise is obtained as the number of octaves is increased. The distribution of noise is varied by changing the seed value.

It is also conceivable to vary the width of the levels of bright-dark information of the noise as the noise variable. In this case, the user designates generating noise using all the 256 levels of the bright-dark information, or designates generating noise using 0 to 128 levels from the 256 levels, for example.

In the first exemplary embodiment, the user may designate the value of the interval at which the composite images are changed over in the continuous image. Incidentally, an image is easily perceived as a still image if the interval at which the composite images are changed over is long. Therefore, the user may adjust the interval at which the composite images are changed over such that the continuous image is recognizable as an image that contains motion, rather than as a still image.

A fixed value is used as the noise variable or the interval at which the composite images are changed over if not designated by the user.

In the example discussed above, the mask images have bright-dark information. However, the present invention is not limited thereto. The mask images may have chromatic color such as red, for example, rather than achromatic color. In this case, the mask images are generated on the basis of random noise that has reddish color, for example, and the pixels of the mask images are given reddish color with random brightness and saturation. The mask images may not be images that represent color values in a color space such as RGB values, and may be noise images with random values of indices such as permeability (transparency), for example.

In the example discussed above, the region in the background image to be combined with the mask images is designated by the user. However, such a region may be designated automatically, rather than by the user. For example, in the example illustrated in FIG. 5, the region A1 is designated by the user dragging using the mouse or the like. In the case where the region is designated automatically, however, a collection (region) of pixels in the background image in which the color value is in a predetermined range is designated as the region A1, for example. Alternatively, the position of the region A1 in the background image may be designated statically using coordinate information, for example.

### Second Exemplary Embodiment

Next, a second exemplary embodiment will be described.

In the first exemplary embodiment, one region in a background image is designated by the user or the like, and noise is combined with the designated region. In the second exemplary embodiment, in contrast, plural regions in a background image are designated, and noise generated using different noise variables is combined with the designated plural regions.

The functional configuration of the image processing device 10 according to the second exemplary embodiment is the same as that in FIG. 2. The image information acquisition section 11, the user instruction receiving section 12, the continuous image generating section 15, and the image information output section 16 are the same in function as those according to the first exemplary embodiment. Hence, the mask generating section 13 and the image combining section 14 will be described below as differences from the first exemplary embodiment.

In the second exemplary embodiment, plural regions in the background image are designated in accordance with an instruction received by the user instruction receiving section 12. The mask generating section 13 generates mask images with the noise variable varied for each of the designated plural regions. In other words, a noise variable corresponding to each of the designated plural regions is set, and different types of mask images are generated for each of the plural regions on the basis of the set noise variable.

The image combining section 14 combines different types of mask images for each of the designated plural regions. The image combining section 14 applies noise with a high frequency and the thickness/paleness of which is varied abruptly to a small region, among the designated plural regions, for example. Fine (abrupt) motion is expressed by applying noise with a high frequency and the thickness/paleness of which is varied abruptly. The image combining section 14 applies noise with a low frequency and the thickness/paleness of which is varied gently to a large region, for example. Great (gentle) motion is expressed by applying noise with a low frequency and the thickness/paleness of which is varied gently.

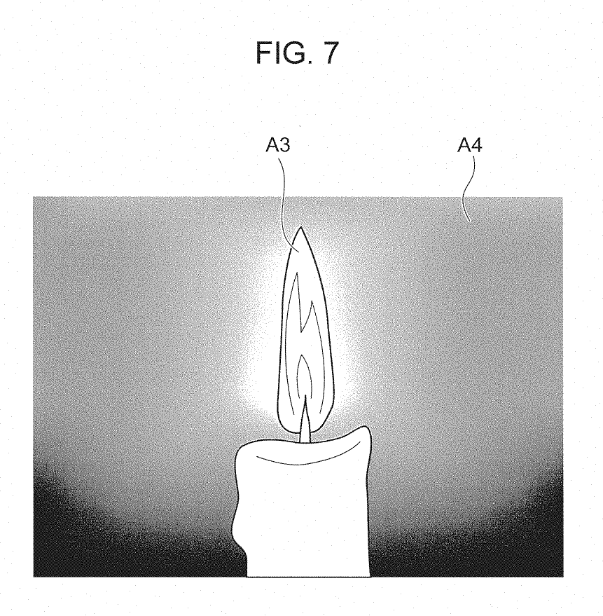

FIG. 7 illustrates an example of a process for combining mask images generated using different noise variables with plural regions. In the example illustrated in FIG. 7, a region A3 in which a flame burning at the end of the wick of a candle and the other region A4 are designated as regions in the background image. The region A3 is smaller than the region A4, for example. Therefore, noise with a higher frequency than that of noise applied to the region A4 is applied to the region A3. Applying noise in this way gives an impression that motion is finer at the center portion of the flame than around the flame.

The noise variable may be set automatically in accordance with the size of the region, or may be designated by the user for each region.

In another example, it is conceivable that the mask generating section 13 generates mask images with the range of the levels of bright-dark information, which serves as the noise variable, varied. In this case, the image combining section 14 applies noise using all the 256 levels of the bright-dark information for one region in the background image, and applies noise using 0 to 128 levels of the bright-dark information for another region in the background image, for example. Fine (abrupt) motion is expressed by applying noise with a wide range of the bright-dark information. Great (gentle) motion is expressed by applying noise with a narrow range of the bright-dark information.

In the second exemplary embodiment, in this way, the image combining section 14 combines mask images generated using different noise variables with designated plural regions in the background image. Different types of motion are expressed in each of the regions by combining mask images generated using different noise variables with each of the regions. In the example discussed above, the plural regions in the background image to be combined with the mask images are designated by the user. However, such regions may be designated automatically on the basis of the color value or the like, rather than by the user, as in the first exemplary embodiment.

### Third Exemplary Embodiment

Next, a third exemplary embodiment will be described.

In the first exemplary embodiment, the plural mask images are images generated on the basis of random noise, and do not have directivity. In the third exemplary embodiment, in contrast, the plural mask images are generated so as to have directivity on the basis of random noise.

The functional configuration of the image processing device 10 according to the third exemplary embodiment is the same as that in FIG. 2. The image information acquisition section 11, the user instruction receiving section 12, the image combining section 14, the continuous image generating section 15, and the image information output section 16 are the same in function as those according to the first exemplary embodiment. Hence, the mask generating section 13 will be described below as a difference from the first exemplary embodiment.

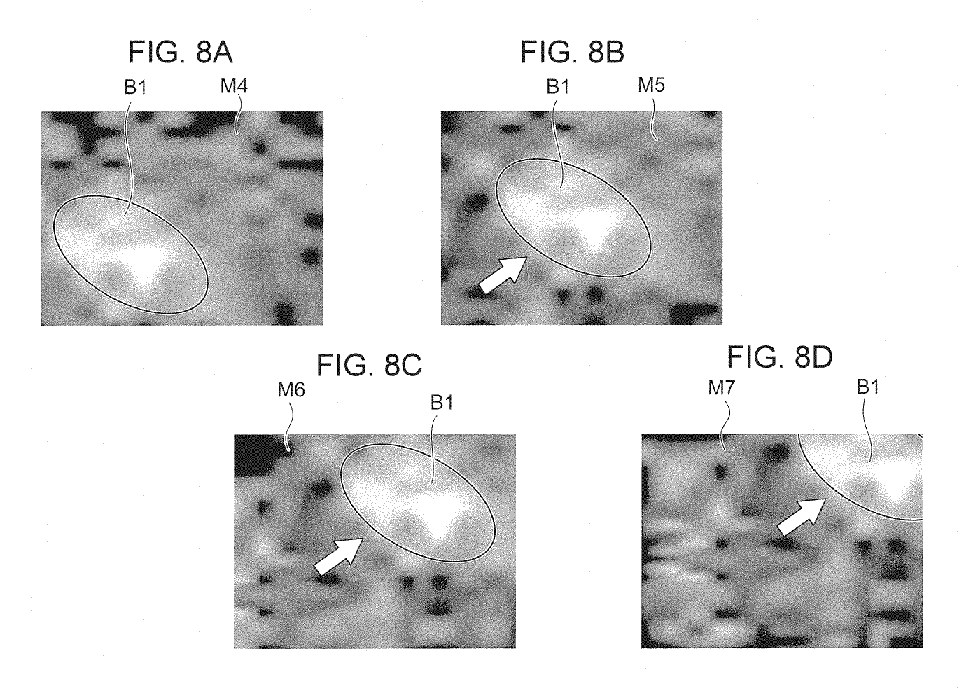

The mask generating section 13 generates plural mask images that have directivity. FIGS. 8A to 8D illustrate examples of a mask image that has directivity. In the examples illustrated in FIGS. 8A to 8D, four mask images (a mask image M4 in FIG. 8A, a mask image M5 in FIG. 8B, a mask image M6 in FIG. 8C, and a mask image M7 in FIG. 8D) are indicated. The mask images M4 to M7 are images generated on the basis of Perlin noise, and have directivity with respect to each other.

More specifically, in the mask image M4, a white component is strong in a region B1 compared to other regions. The mask images M4 to M7 are provided with directivity by moving an image in the region B1. That is, in the mask image M5, the image in the region B1 has been moved in the direction of the arrow from the position in the mask image M4. In the mask image M6, the image in the region B1 has been moved in the direction of the arrow from the position in the mask image M5. In the mask image M7, the image in the region B1 has been moved in the direction of the arrow from the position in the mask image M6.

In this way, the mask images M1 to M4 may be provided with directivity in the direction indicated by the arrow by moving the image in the region B1, which is common to the mask images M4 to M7, in the direction of the arrow. The direction in which the common image is to be moved, such as the direction of the arrow indicated in FIGS. 8A to 8D, may be designated by the user, or may be designated statically.

In this way, in the third exemplary embodiment, the mask generating section 13 generates plural mask images so as to have specific directivity. The image combining section 14 combines a background image and plural mask images that have specific directivity. In other words, the image combining section 14 applies random noise that has specific directivity to the background image. As a result, an impression that the background image, which is a still image, is moving continuously and such motion of the still image has specific directivity is invoked.

In the example discussed above, an image with a strong white component is used as the image to be moved to provide directivity. However, the present invention is not limited to such a configuration. For example, an image with a strong component in a specific color, such as red, may be moved to provide directivity. If the user desires to emphasize a region in the background image, for example, noise may be moved in the region that the user desires to emphasize to provide directivity. In this case, the region that the user desires to emphasize may be designated by the user using the mouse or the like as illustrated in FIG. 5, for example. The direction in which noise is to be moved may be designated by the user dragging using the mouse or the like, or may be designated statically, for example.

Mask images that have directivity may be combined with any of the designated plural regions in the background image, or mask images that have different directivities may be combined with each of the designated plural regions, by combining the third exemplary embodiment with the process according to the second exemplary embodiment.

### Fourth Exemplary Embodiment

Next, a fourth exemplary embodiment will be described.

In the third exemplary embodiment, a common image is moved using plural mask images to provide the plural mask images with directivity. In the fourth exemplary embodiment, in contrast, an image for providing directivity is combined with random noise to provide plural mask images with directivity.

The functional configuration of the image processing device 10 according to the fourth exemplary embodiment is the same as that in FIG. 2. The image information acquisition section 11, the user instruction receiving section 12, the image combining section 14, the continuous image generating section 15, and the image information output section 16 are the same in function as those according to the first exemplary embodiment. Hence, the mask generating section 13 will be described below as a difference from the first exemplary embodiment.

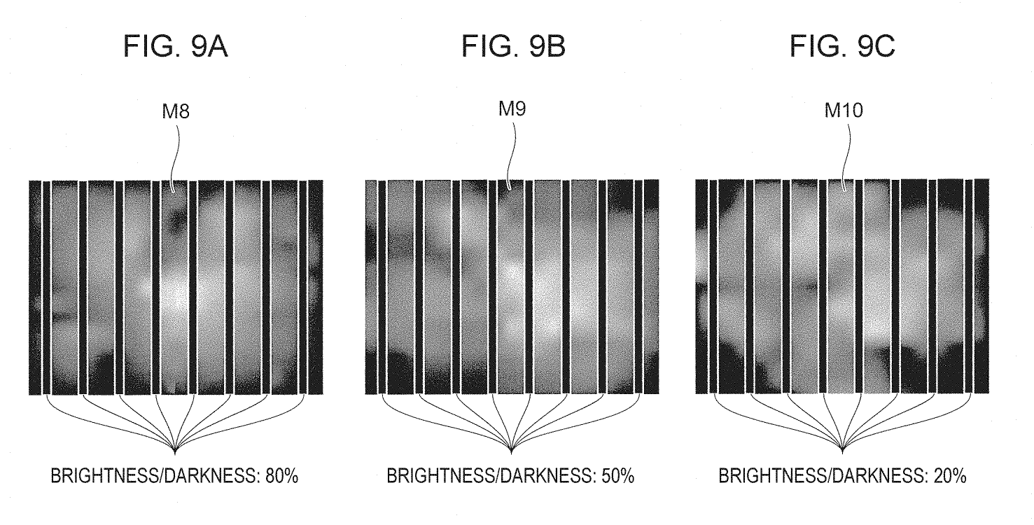

The mask generating section 13 generates plural mask images that have directivity. FIGS. 9A to 9C illustrate other examples of the mask image that has directivity. In the examples illustrated in FIGS. 9A to 9C, three mask images (a mask image M8 in FIG. 9A, a mask image M9 in FIG. 9B, and a mask image M10 in FIG. 9C) are indicated. In the mask images M8 to M10, a pattern in which vertical lines are arranged at constant intervals has been combined with Perlin noise.

More specifically, the Perlin noise is different among the mask images M8 to M10, and the brightness/darkness (thickness/paleness) of pixels to be superposed on the vertical lines is varied among the mask images M8 to M10. For example, if the brightness/darkness of pixels for the Perlin noise is defined as 100%, the brightness/darkness of pixels to be superposed on the vertical lines is determined as 80% in the mask image M8. The brightness/darkness of pixels to be superposed on the vertical lines is determined as 50% in the mask image M9. The brightness/darkness of pixels to be superposed on the vertical lines is determined as 20% in the mask image M10. Changing the brightness/darkness of pixels to be superposed on the vertical lines among the mask images M8 to M10 in this way may provide the mask images M8 to M10 with directivity in the vertical direction.

Likewise, in the case where a pattern in which horizontal lines are arranged at constant intervals is combined with Perlin noise, for example, and the brightness/darkness (thickness/paleness) of pixels to be superposed on the horizontal lines is varied among the mask images, the plural mask images may be provided with directivity in the horizontal direction. In the case where a pattern in which oblique lines are arranged at constant intervals is combined with Perlin noise, for example, and the brightness/darkness (thickness/paleness) of pixels to be superposed on the oblique lines is varied among the mask images, the plural mask images may be provided with directivity in the oblique direction.

The pattern to be combined with noise may be designated by the user from plural sample patterns, or may be designated statically, for example.

In this way, in the fourth exemplary embodiment, the mask generating section 13 generates mask images by combining images that provide specific directivity with random noise. The image combining section 14 combines a background image and plural mask images that have specific directivity. As a result, an impression that the background image, which is a still image, is moving continuously and such motion of the still image has specific directivity is invoked.

In the example discussed above, a pattern in which lines are arranged at constant intervals is used to provide mask images with directivity. However, a pattern in which lines are arranged at different intervals may also be used. Alternatively, the interval of the lines may be varied among the mask images, for example.

The pattern is not limited to a pattern in which lines are arranged, and a ripple pattern with multiple circles may also be used, for example. In this case, the circles may be arranged at constant intervals or different intervals, or the interval of the circles may be varied among the mask images, for example.

Mask images that have directivity may be combined with any of the designated plural regions in the background image, or mask images that have different directivities may be combined with each of the designated plural regions, by combining the fourth exemplary embodiment with the process according to the second exemplary embodiment.

In the description of the first to fourth exemplary embodiments, the mask images (random images) are images generated on the basis of random noise. However, the mask images are not limited to those generated on the basis of random noise. The exemplary embodiments utilize the nature of human vision that it tries to find regularity (continuity) in something random or irregular (non-continuous). Therefore, the mask images may be any images that have common characteristics but are not continuous with each other, and that are generated on the basis of a randomly determined form or pattern. For example, the mask images may be images with a striped pattern constituted of plural parallel or intersecting lines with the thickness of the lines or the interval of the lines varied randomly, or may be images with a ripple pattern constituted of multiple circles with the thickness of the circles or the interval of the circles varied randomly.

<Example of Hardware Configuration of Image Processing Device>

Next, the hardware configuration of the image processing device 10 will be described.

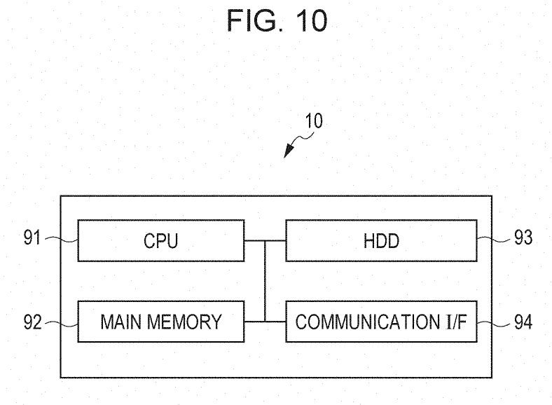

FIG. 10 illustrates an example of the hardware configuration of the image processing device 10.

As discussed above, the image processing device 10 is implemented by a personal computer or the like. As illustrated in the drawing, the image processing device 10 includes a central processing unit (CPU) 91 that serves as a computation unit, and a main memory 92 and a hard disk drive (HDD) 93 that each serve as a storage unit. The CPU 91 executes various types of programs such as an OS and application software. The main memory 92 is a storage region in which the various types of programs, data for execution of such programs, etc., are stored. The HDD 93 is a storage region in which data input to the various types of programs, data output from the various types of programs, etc. are stored.

The image processing device 10 further includes a communication interface 94 (hereinafter referred to as a “communication I/F”) for external communication.

<Program>

The process performed by the image processing device 10 according to the exemplary embodiments described above may be prepared as a program such as application software, for example.

Hence, in the exemplary embodiments, the process performed by the image processing device 10 may be implemented as a program causing a computer to execute image processing including: acquiring a still image; and outputting a continuous image constituted by temporally arranging plural composite images each prepared by combining each of plural non-continuous random images and the still image.

The programs for implementing the exemplary embodiments of the present invention may be not only provided by a communication unit but also provided as stored in a recording medium such as a CD-ROM.

While exemplary embodiments of the present invention have been described above, the technical scope of the present invention is not limited to the exemplary embodiments described above. It is apparent from the following claims that a variety of modifications and improvements that may be made to the exemplary embodiments described above also fall within the technical scope of the present invention.

What is claimed is:

1. An image processing device comprising:
an acquisition unit that acquires a still image; and
an output unit that outputs a continuous image constituted by temporally arranging a plurality of composite images each prepared by combining each of a plurality of non-continuous random images with the still image.

2. The image processing device according to claim 1,
wherein the plurality of random images are images generated on a basis of random noise.

3. The image processing device according to claim 1,
wherein a plurality of regions have been designated in advance in the still image, and
the composite images are images prepared by combining each of the plurality of random images with the still image in such a manner that a different type of the plurality of random images is combined for a different region of the still image.

4. The image processing device according to claim 1,
wherein the plurality of random images are provided with directivity in a specific direction by changing a position of a common image contained in the plurality of random images in the specific direction.

5. The image processing device according to claim 1,
wherein the plurality of random images are provided with directivity in a specific direction by combining an image that provides directivity in the specific direction with different images.

6. The image processing device according to claim 1, further comprising:
a receiving unit that receives, from a user, an instruction for designating regions in the still image to be combined with the plurality of random images.

7. An image processing system comprising:
a display device that displays an image; and
an image processing device that performs image processing on image information on the image to be displayed on the display device,
wherein the image processing device includes
an acquisition unit that acquires a still image, and
an output unit that outputs a continuous image constituted by temporally arranging a plurality of composite images each prepared by combining each of a plurality of non-continuous random images with the still image.

8. An image processing method comprising:
acquiring a still image; and
outputting a continuous image constituted by temporally arranging a plurality of composite images each prepared by combining each of a plurality of non-continuous random images with the still image.

9. A non-transitory computer readable medium storing a program causing a computer to execute image processing comprising:
acquiring a still image; and
outputting a continuous image constituted by temporally arranging a plurality of composite images each prepared by combining each of a plurality of non-continuous random images with the still image.
